(19) United States
(12) Patent Application Publication
(10) Pub. No.: US 2021/0350027 A1
(43) Pub. Date: Nov. 11, 2021

(54) INFORMATION PROCESSING APPARATUS, INFORMATION PROCESSING METHOD AND NON-TRANSITORY RECORDING MEDIUM

(71) Applicant: Daiki Sakurada, KANAGAWA (JP)

(72) Inventor: Daiki Sakurada, KANAGAWA (JP)

(73) Assignee: Ricoh Company, Ltd., Tokyo (JP)

(21) Appl. No.: 17/232,345

(22) Filed: Apr. 16, 2021

(30) Foreign Application Priority Data
May 7, 2020 (JP) 2020-082213

(51) Int. Cl. G06F 21/64; G06F 21/74; G06F 21/44

(52) U.S. Cl. CPC G06F 21/64; G06F 2221/2141; G06F 21/44; G06F 21/74

(57) ABSTRACT

An information processing apparatus, an information processing method, and a non-transitory recording medium. The information processing apparatus creates in one or more memories, a partition in a verification target area for verifying integrity and authenticity and a partition in a non-verification target area for not verifying the integrity and authenticity, stores a compressed file and authentication data created from the compressed file in the partition in the verification target area of one or more memories, verifies a signature of the compressed file using the compressed file and the authentication data stored in the partition in the verification target area of the one or more memories, and based on a successful result of the signature verification, decompresses, and expands the compressed file to the partition in the non-verification target area of the one or more memories.

### CROSS-REFERENCE TO RELATED APPLICATIONS

This patent application is based on and claims priority pursuant to 35 U.S.C. § 119(a) to Japanese Patent Application No. 2020-082213, filed on May 7, 2020 in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

In recent years, technique that detects unauthorized alteration of files (firmware, software) that make up the system and allows only legitimate files to be executed while the system is starting up (for example, Trusted Startup and LINUX-IMA) to guarantee integrity and authenticity in the information processing apparatus is known.

Techniques that guarantee integrity and authenticity by allowing only legitimate files to be executed while the system is starting (for example, Trusted Boot, LINUX-IMA, etc.) save authentication data such as expected hash value (measured value) and electronic signature for the target file in advance, and the integrity and authenticity are confirmed on a file-by-file basis by comparing and verifying the expected value and electronic signature while the system is starting up.

### SUMMARY

Embodiments of the present disclosure describe an information processing apparatus, an information processing method, and a non-transitory recording medium. The information processing apparatus creates in one or more memories, a partition in a verification target area for verifying integrity and authenticity and a partition in a non-verification target area for not verifying the integrity and authenticity, stores a compressed file and authentication data created from the compressed file in the partition in the verification target area of one or more memories, verifies a signature of the compressed file using the compressed file and the authentication data stored in the partition in the verification target area of the one or more memories, and based on a successful result of the signature verification, decompresses, and expands the compressed file to the partition in the non-verification target area of the one or more memories.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating a hardware configuration of an information processing apparatus according to embodiments of the present disclosure;

FIG. 2 is a block diagram illustrating a software configuration of an information processing apparatus, according to embodiments of the present disclosure;

FIG. 3 is a diagram illustrating a general process for verifying integrity and authenticity of files at system startup;

FIG. 4 is a diagram illustrating a process for verifying the integrity and authenticity of files at system startup, according to embodiments of the present disclosure;

FIG. 5 is a diagram illustrating an example of an Integrity Measurement Architecture (IMA) policy file for setting a verification target area by a file system;

FIG. 6 is an activity diagram illustrating a system update application according to embodiments of the present disclosure;

FIG. 7 is an activity diagram illustrating a system update file compression application according to embodiments of the present disclosure;

FIG. 8 is an activity diagram illustrating a partition creation application according to embodiments of the present disclosure;

FIG. 9 is an activity diagram illustrating a confirmation process for the integrity and authenticity of a file at system startup according to embodiments of the present disclosure;

FIG. 10 is a diagram illustrating an example of an IMA policy file that sets a verification target area by Universally Unique Identifier (UUID);

FIG. 11 is a diagram illustrating a process for verifying the integrity and authenticity of files at system startup, according to embodiments of the present disclosure;

FIG. 12 is a block diagram illustrating a hardware configuration of a personal computer (PC) (server) according to embodiments of the present disclosure; and

FIG. 13 is a block diagram illustrating a hardware configuration of a multifunction peripheral (MFP) according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring to the drawings, embodiments of the present disclosure is described. In order to facilitate understanding of the description, the same components are denoted by the same reference numerals in the respective drawings as much as possible, and redundant description is omitted.

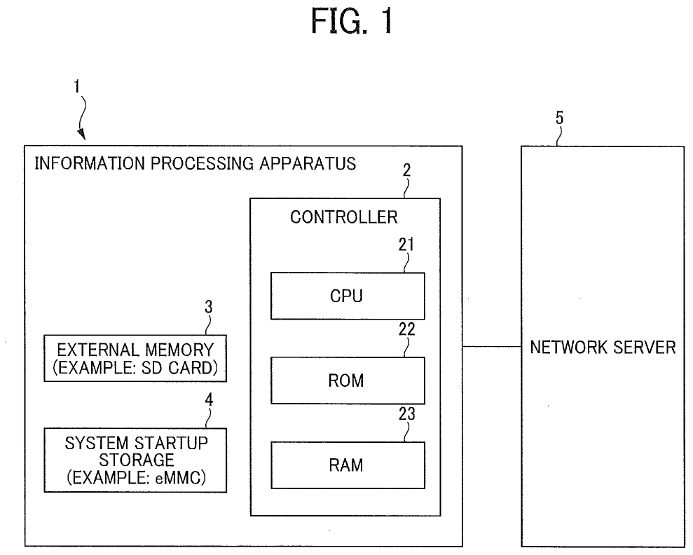

FIG. 1 is a block diagram illustrating a hardware configuration of an information processing apparatus 1 according to the present embodiment. As illustrated in FIG. 1, the information processing apparatus 1 includes a controller 2, an external memory 3, and a system startup storage 4. The information processing apparatus 1 is communicably connected to a network server 5 through a network line such as the internet.

The controller 2 controls the entire operation of the information processing apparatus 1. The controller 2 guarantees integrity and authenticity of a file by detecting unauthorized alteration of a file (firmware, software, etc.) included in the system.

The controller 2 includes a central processing unit (CPU) 21, a read only memory (ROM) 22, and a random access memory (RAM) 23. The CPU 21 controls the operation of the entire information processing apparatus 1. The ROM 22 stores programs used to drive the CPU 21, such as an initial program loader (IPL). The RAM 23 is used as a work area of the CPU 21.

The files (firmware, software) included in the system are stored in the system startup storage 4. Examples of storage include an embedded Multimedia Card (eMMC) and the like.

A new system update (ROM update) file (system update file) stored in the network server 5 is stored in the external memory 3. An example of the external memory 3 is a secure digital (SD) card or the like. The system update file stored in the external memory 3 is written in the system startup storage 4. Further, the network server 5 stores a system update file for newly performing a system update (ROM update).

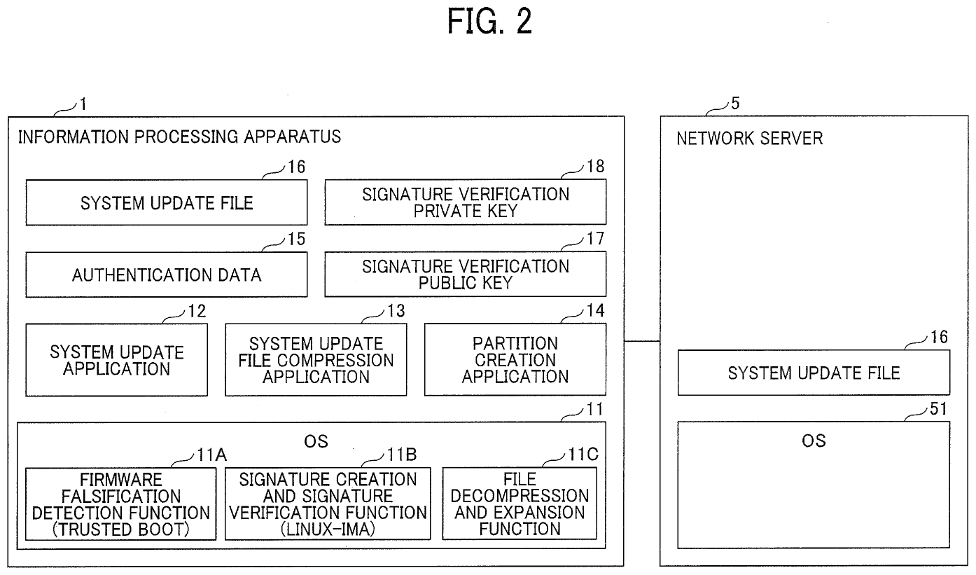

FIG. 2 is a block diagram illustrating a software configuration of an information processing apparatus 1, according to the present embodiment. As illustrated in FIG. 2, the information processing apparatus 1 includes an operating system (OS) 11, a system update application 12, a system update file compression application 13, and a partition creation application 14. Further, the information processing apparatus 1 stores authentication data 15, the system update file 16, a signature verification public key 17, and a signature verification private key 18.

The OS 11 controls the entire information processing apparatus 1. In addition, OS 11 has a firmware falsification detection function 11A, a signature creation and signature verification function 11B, and a file decompression and expansion function 11C. The firmware falsification detection function 11A is implemented by, for example, Trusted Boot. The firmware falsification detection function 11A detects tampering with the firmware (for example, basic input/output system (BIOS) or startup loader) used at system startup.

The signature creation and signature verification function 11B is implemented by, for example, LINUX-IMA. The signature creation and signature verification function 11B performs signature creation and signature verification (verification of integrity and authenticity of file) of the compressed file described below, after the firmware is started. The file decompression and expansion function 11C performs a process of decompressing and expanding a compressed file, based on verification of the integrity and authenticity of the compressed file.

The system update file compression application 13 compresses the system update file stored in the external memory 3 into one file. The system update application 12 stores the system update file compressed by the system update file compression application 13 in a partition in a verification target area described below in the system startup storage 4.

The partition creation application 14 creates, in the storage area of the system startup storage 4, the partition in the verification target area for verifying the integrity and authenticity of the file and a partition in a non-verification target area for not verifying the integrity and authenticity.

The authentication data 15 is data used by the signature creation and signature verification function 11B to verify signature of the system update file 16 that is compressed. The system update file 16 stores files (firmware, software) for configuring the system. The signature verification public key 17 is public key data used for signature verification of the compressed system update file 16. The signature verification private key 18 is private key data used for signature verification of the compressed system update file 16.

The network server 5 includes an OS 51. Further, the network server 5 stores the data of the system update file 16. The OS 51 controls the entire network server 5. The system update file 16 stores files (firmware, software) for configuring the system.

The processing of the OS 11, the system update application 12, the system update file compression application 13, and the partition creation application 14 of FIG. 2 is implemented by executing processing according to the program by the CPU 21 illustrated in FIG. 1 using the RAM 23 as a work area.

Hereinafter, processing or operation of each embodiment is described.

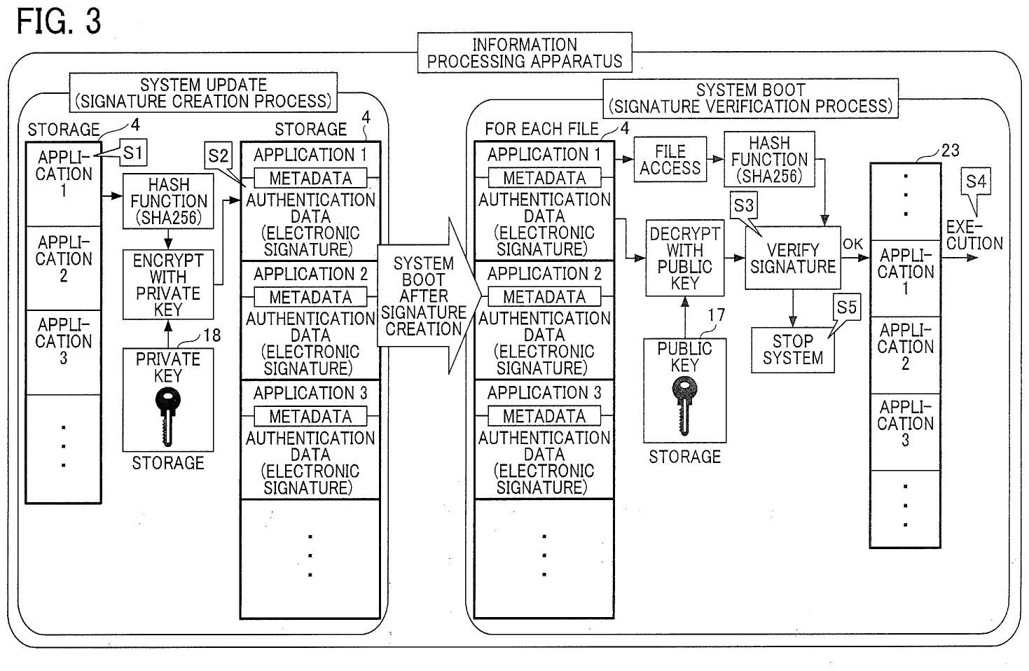

FIG. 3 is a diagram illustrating a general process for verifying integrity and authenticity of files at system startup. At the time of system update, files of firmware and software (for example, “application 1”, “application 2”, “application 3”, etc. in FIG. 3) included in the system are stored in the system startup storage 4 of the information processing apparatus 1 (step S1).

In step 2, authentication data is created for each file stored in the system startup storage 4, and the authentication data (electronic signature) is stored in a metadata area of each file. The authentication data can be created, for example, by performing a hash operation on a file and encrypting a generated hash value with the signature verification private key 18.

At the system startup, the signature creation and signature verification function 11B of the information processing apparatus 1 performs signature verification on a file-by-file basis when executing the file stored in the system startup storage 4 in step S1. Here, the signature verification is performed by comparing the value obtained by decrypting the authentication data saved in step S2 with the signature verification public key 17 and the value generated by performing the hash operation on the file to be executed (step S3).

If the signature verification is successful, the file to be executed is expanded in the RAM 23 and executed (step S4). If the signature verification fails, the file to be executed is detected as an invalid file, and the file execution (system) is stopped (step S5).

The processing image for verifying the integrity and authenticity of the file illustrated in FIG. 3 describes a mechanism for verifying the integrity and authenticity of the file after the kernel is started. To verify the integrity and authenticity of the firmware (BIOS, startup loader, etc.) that is started before LINUX-IMA is enabled, for example, the mechanism of the firmware falsification detection function 11A by Trusted Startup is used.

In the process illustrated in FIG. 3, the integrity and authenticity of all the files used are verified on a file-by-file basis when the system is started. Therefore, when there are more files to verify the integrity and authenticity, longer processing time is required for verifying the integrity and authenticity.

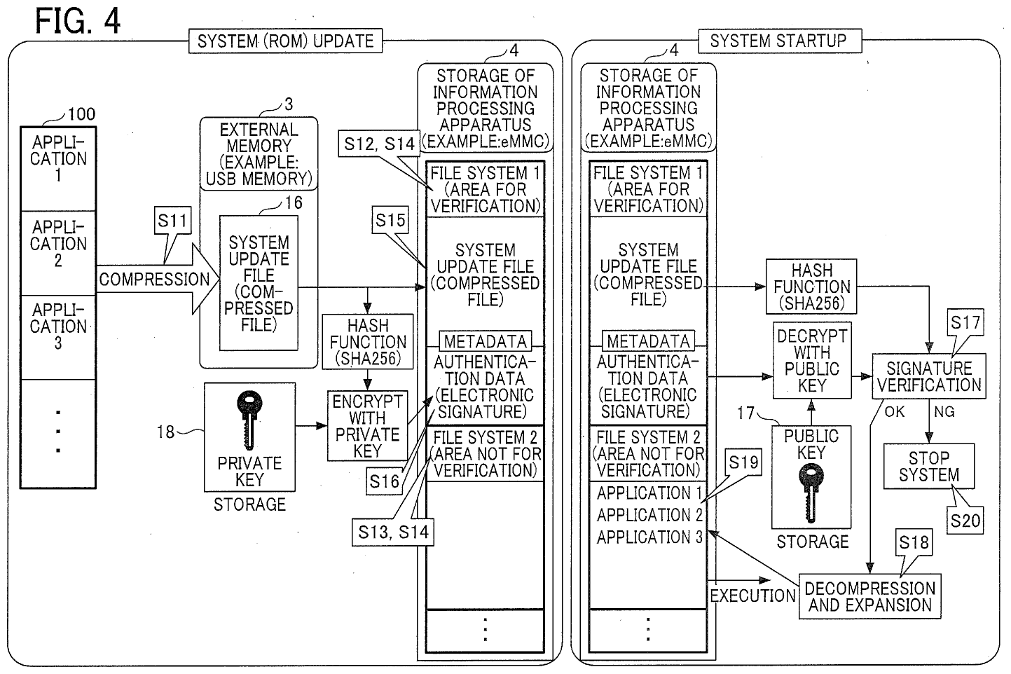

In the present embodiment, the integrity and authenticity of the file are verified at system startup as indicated by the processing image illustrated in FIG. 4 to shorten the processing time for verifying integrity and authenticity (processing time for signature creation and signature verification). FIG. 4 is a diagram illustrating a process for verifying the integrity and authenticity of files at system startup, according to the present embodiment.

When updating the system (ROM), a process of storing the system update file 16 acquired from the network server 5 and stored in the external memory 3 in the system startup storage 4 is performed. In step S11, for example, the system update file compression application 13 of the information processing apparatus 1 compresses all the files 100 that make up firmware and software (for example, “application 1”, “application 2”, “application 3”, etc. in FIG. 4) of the system, and generates one system update file 16. The process of generating one system update file 16 by compressing all the files 100 that make up the system may be performed by the network server 5. Hereinafter, the system update file 16 generated by compressing all the files 100 that make up the system is referred to as a compressed system update file 16.

In step S12, the partition creation application 14 of the information processing apparatus 1 creates a partition formatted by, for example, “file system 1” in the storage area of the system startup storage 4. In step S13, the partition creation application 14 of the information processing apparatus 1 creates a partition formatted by, for example, “file system 2” in the storage area of the system startup storage 4.

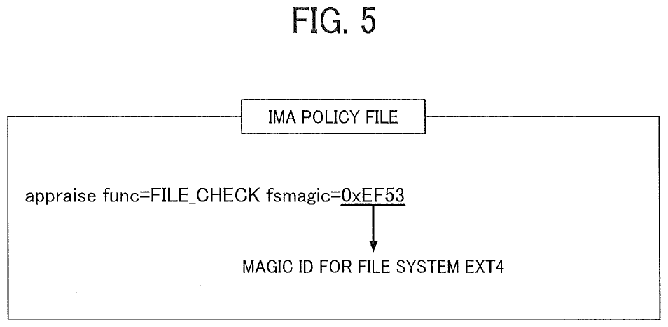

In LINUX-IMA, for example, the file system of the verification target area is set in the IMA policy file as illustrated in FIG. 5. The partition formatted by the file system set as the verification target area in the IMA policy file as illustrated in FIG. 5 becomes a partition of verification target area. Further, a partition formatted by the file system that is not set as the verification target area in the IMA policy file as illustrated in FIG. 5 becomes a partition of non-verification target area. FIG. 5 is a diagram illustrating an example of the IMA policy file for setting the verification target area by the file system.

The partition creation application 14 sets “file system 1” as the file system of the verification target area in the IMA policy file as illustrated in FIG. 5. In step S14, a partition in the verification target area and a partition in the non-verification target area are created in the system startup storage 4 of the information processing apparatus 1.

In step S15, the system update application 12 of the information processing apparatus 1 stores the compressed system update file 16 in the partition in the verification target area created in the system startup storage 4. The signature creation and signature verification function 11B of the information processing apparatus 1 creates authentication data from the compressed system update file 16 and stores the authentication data (electronic signature) in the metadata area of the compressed system update file 16. In step S16, the authentication data is created by performing a hash operation on the compressed system update file 16 and encrypting a generated value with the signature verification private key 18.

In step S17, at system startup, the signature creation and signature verification function 11B of the information processing apparatus 1 performs signature verification with the compressed system update file 16 stored in the partition in the verification target area in step S15 and the authentication data stored in the metadata area of the compressed system update file 16. Specifically, the signature creation and signature verification function 11B performs the signature verification by comparing the value obtained by decrypting the authentication data stored in step S16 with the signature verification public key 17 and the value generated by performing the hash operation on the compressed system update file 16.

When the signature verification is successful, the file decompression and expansion function 11C of the information processing apparatus 1 decompresses the compressed system update file 16 to acquire all files 100 that makeup the system. In step S18, the file decompression and expansion function 11C expands all the files 100 that make up the system into the partition in the non-verification target area. In step S19, all the files 100 that make up the system expanded in the partition in the non-verification target area are ready to be executed.

In step S20, if the signature verification fails, the file decompression and expansion function 11C of the information processing apparatus 1 detects the compressed system update file 16 as an invalid file and stops the system.

As described above, in the present embodiment, a plurality of partitions are created in the system startup storage 4, including the partition in the verification target area for verifying the integrity and authenticity and the partition in the non-verification target area for not verifying the integrity and authenticity, depending on the file system type of each partition.

In the partition in the verification target area for verifying the integrity and authenticity, the system update file 16, which is generated by collectively compressing the firmware and software (the entire files) included in the system into one, is stored. Thereby, in the present embodiment, the number of files for verifying integrity and authenticity (number of file verifications) can be reduced. Further, in the present embodiment, the data size of the file for verifying integrity and authenticity can be reduced by compression. In the present embodiment, the processing time for verifying the integrity and authenticity of the file can be shortened by reducing the number of file verifications and the data size.

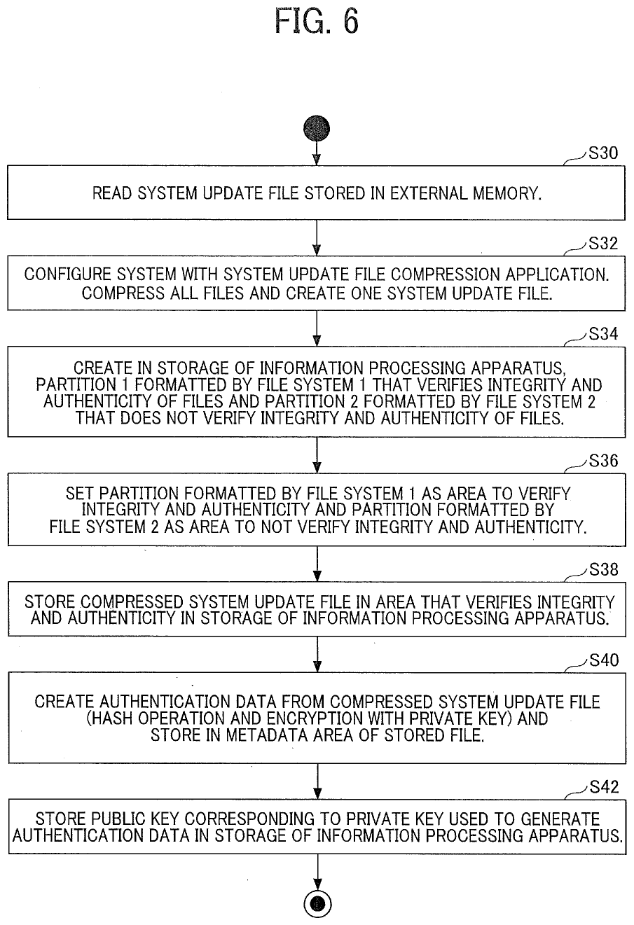

FIG. 6 is an activity diagram of the system update application 12 of the present embodiment. In step S30, at the time of system update, the system update application 12 reads the system update file stored in the external memory 3 (stored in a particular directory of the external memory 3). The system update file stored in the external memory 3 may be a plurality of files included in the system or may be one system update file 16 in which all the files 100 that make up the system is compressed by the network server 5.

In step S32, if the system update file stored in the external memory 3 is a plurality of files included in the system, the system update application 12 uses the system update file compression application 13 to compress all the files 100 that make up the system and generates one system update file 16. If the compressed system update file 16 is stored in the external memory 3, the system update application 12 skips the process of step S32.

In step S34, the system update application 12 uses the partition creation application 14 to verify the integrity and authenticity of the file in the storage area of the system startup storage 4. For example, a partition in the verification target area formatted by “file system 1” and a partition in the non-verification target area formatted by “file system 2” for which the integrity and authenticity of the file is not to be verified are created.

In step S36, the system update application 12 under the control of LINUX-IMA, sets “file system 1” as the file system of the verification target area in the IMA policy file as illustrated in FIG. 5. As a result, the partition managed by “file system 1” is set as an area to verify the integrity and authenticity. In addition, the system update application 12 under the control of LINUX-IMA, for example, by not setting “file system 2” as the file system of the verification target area in the IMA policy file as illustrated in FIG. 5, the partition managed by the “file system 2” is set as an area for not verifying the integrity and authenticity.

Although an example of a file system for formatting a partition is described here, similar settings are possible when a file system such as squashfs that directly compresses and decompresses in the RAM 23 is set as a file system in a verification target area for verifying the integrity and authenticity.

In step S38, the system update application 12 stores the compressed system update file 16 in the partition in the verification target area created in the system startup storage 4. In step S40, the system update application 12 under the control of LINUX-IMA, creates authentication data from the compressed system update file 16 and stores the authentication data (electronic signature) in the metadata area of the compressed system update file 16. The authentication data is created by performing the hash operation on the compressed system update file 16 and encrypting the generated value with the signature verification private key 18.

In step S42, the system update application 12 stores the signature verification public key 17 corresponding to the signature verification private key 18 used for creating the authentication data (electronic signature) in the system startup storage 4 or the like.

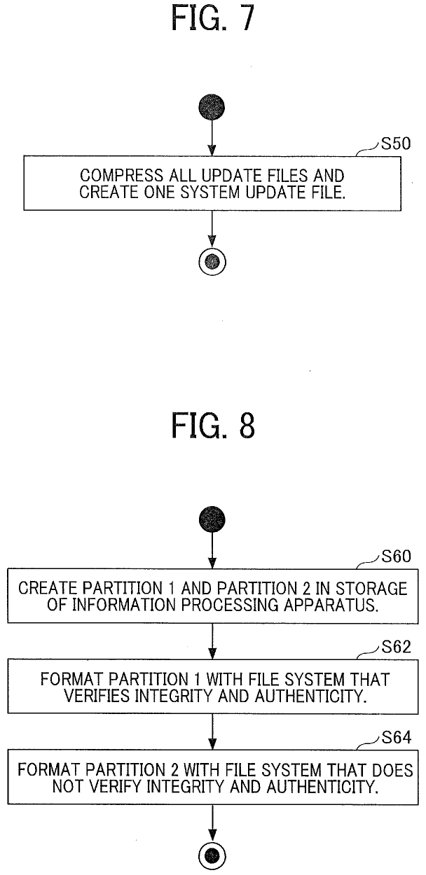

FIG. 7 is an activity diagram of the system update file compression application 13 of the present embodiment. In step S50, the system update file compression application 13 generates one compressed system update file 16 by compressing all the files 100 that make up the system.

When the network server 5 generates the compressed system update file 16, the system update file compression application 13 of the information processing apparatus 1 is provided on the network server 5.

FIG. 8 is an activity diagram of the partition creation application 14 of the present embodiment. When the system is updated, the partition creation application 14 of the information processing apparatus 1 creates, for example, “partition 1” and “partition 2” in the storage area of the system startup storage 4 in step S60.

In step S62, when setting “partition 1” as the verification target area for verifying the integrity and authenticity, the partition creation application 14 formats, for example, by the “file system 1” such as ext4 that is set as the file system of the verification target area in the IMA policy file illustrated in FIG. 5. In step S64, when setting “partition 2” as an area not to verify the integrity and authenticity, the partition creation application 14 formats by the “file system 2” such as xfs which is not set as the file system of the verification target area in the IMA policy file of FIG. 5.

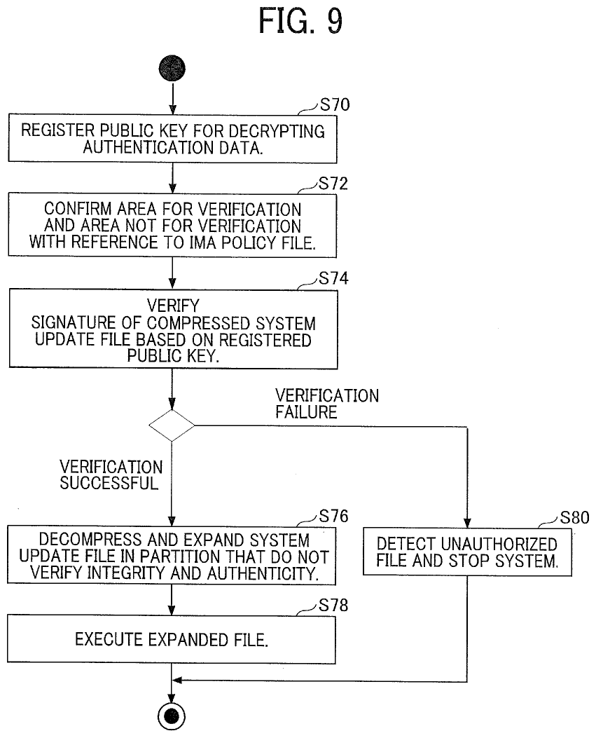

FIG. 9 is an activity diagram illustrating a verification process for the integrity and authenticity of a file at system startup according to the present embodiment. In step S70, the signature creation and signature verification function 11B of the information processing apparatus 1 reads and stores the signature verification public key 17 for decrypting the authentication data from the system startup storage 4 or the like at system startup. In step S72, the signature creation and signature verification function 11B verifies the partition in the verification target area and the partition in the non-verification target area by referring to the IMA policy file as illustrated in FIG. 5.

In step S74, the signature creation and signature verification function 11B performs signature verification on the compressed system update file 16 stored in the partition in the verification target area based on the signature verification public key 17 stored in step S70.

Specifically, the signature creation and signature verification function 11B performs signature verification by comparing a value obtained by decrypting the authentication data stored in the metadata area of the compressed system update file 16 with the signature verification public key 17 and a value generated by performing hash operation on the compressed system update file 16.

In step S76, if the signature verification is successful, the signature creation and signature verification function 11B uses the file decompression and expansion function 11C to decompress and expand the compressed system update file 16 to the partition in the non-verification target area. In step S78, all the files 100 that makeup the system expanded in the partition in the non-verification target area are executed. In step S80, if the signature verification fails, the signature creation and signature verification function 11B detects the compressed system update file 16 as an invalid file and stops the system.

According to the present embodiment, the processing time for verifying the integrity and authenticity of the file can be shortened.

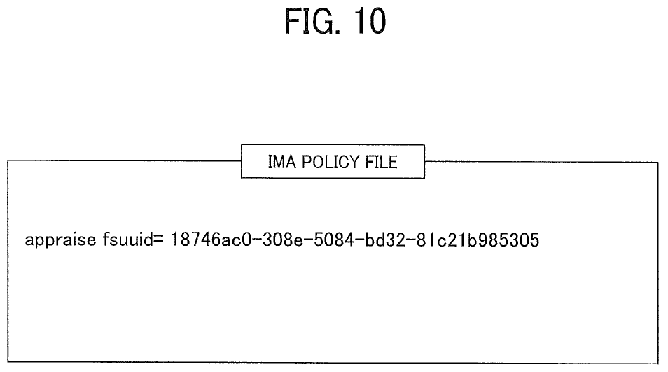

The IMA policy file of FIG. 5 is an example, and the partition in the verification target area may be set by a unique ID (for example, UUID) assigned to each partition, for example, as in the IMA policy file of FIG. 10. A partition that is not set as a partition in the verification target area in the IMA policy file of FIG. 10 is a partition in the non-verification target area.

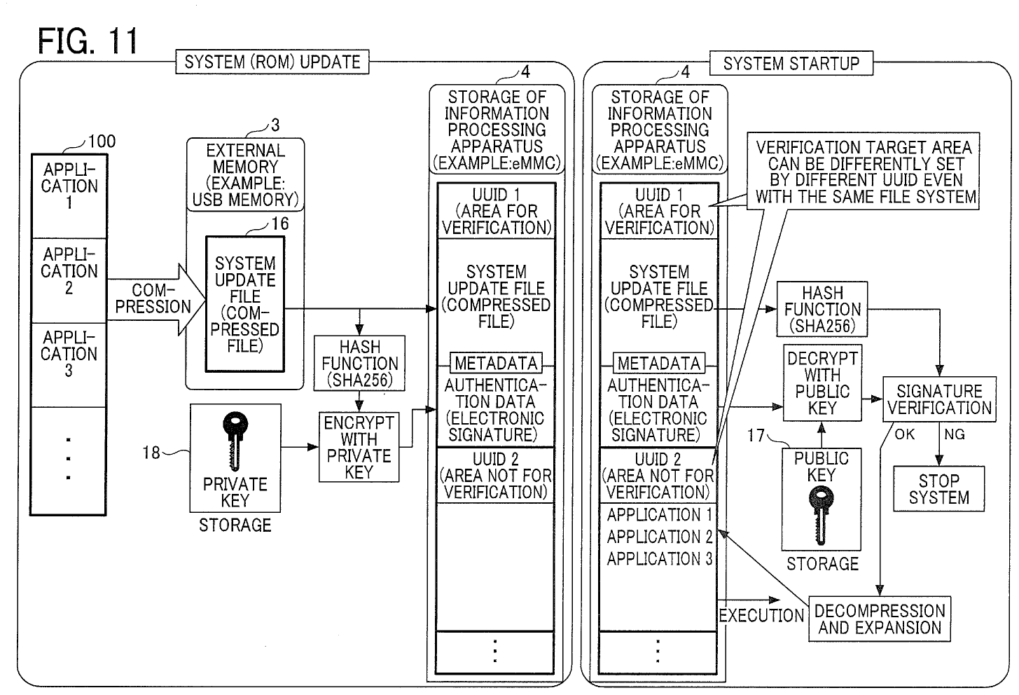

FIG. 11 is a diagram illustrating a process for verifying the integrity and authenticity of files at system startup, according to another embodiment. In FIG. 4, a partition of a verification target area for verifying integrity and authenticity and a partition of a non-verification target area for which integrity and authenticity are not verified are created, depending on the type of file system.

On the other hand, in FIG. 11, a partition in the verification target area for verifying the integrity and authenticity and a partition in the non-verification target area for which the integrity and authenticity are not verified are created depending on the UUID of the partition.

For example, the system update application 12 sets the “UUID1” of the “partition 1” to be the verification target area in the IMA policy file as illustrated in FIG. 10 under the control of LINUX-IMA, and the partition identified by the “UUID1” is set as an area for verifying the integrity and authenticity.

Further, at the system update application 12, under the control of LINUX-IMA, for example, by not setting “UUID2” of “partition 2” to the verification target area in the IMA policy file as illustrated in FIG. 10, the partition identified by “UUID2” is set as an area for which the integrity and authenticity are not verified.

According to the present embodiment illustrated in FIGS. 10 and 11, creating the partition in the verification target area for verifying the integrity and authenticity and the partition in the non-verification target area for which the integrity and authenticity are not verified is possible, even in a case of creating partitions using the same type of file system.

The information processing apparatus 1 according to the present embodiment is not limited to the configuration illustrated in FIG. 1 as long as the apparatus includes a function of verifying the integrity and authenticity of a file at the time of system startup or the like. The information processing apparatus 1 may be, for example, an output device such as a projector (PJ), an interactive white board ((IWB) a white board having an electronic blackboard function capable of mutual communication), a digital signage, a head up display (HUD) device, an industrial machine, an imaging device, a sound collecting device, a medical device, a network home appliance, an automobile (connected car), a notebook PC, a mobile phone, a smartphone, a tablet terminal, a game console, a personal digital assistant (PDA), a digital camera, a wearable PC or a desktop PC.

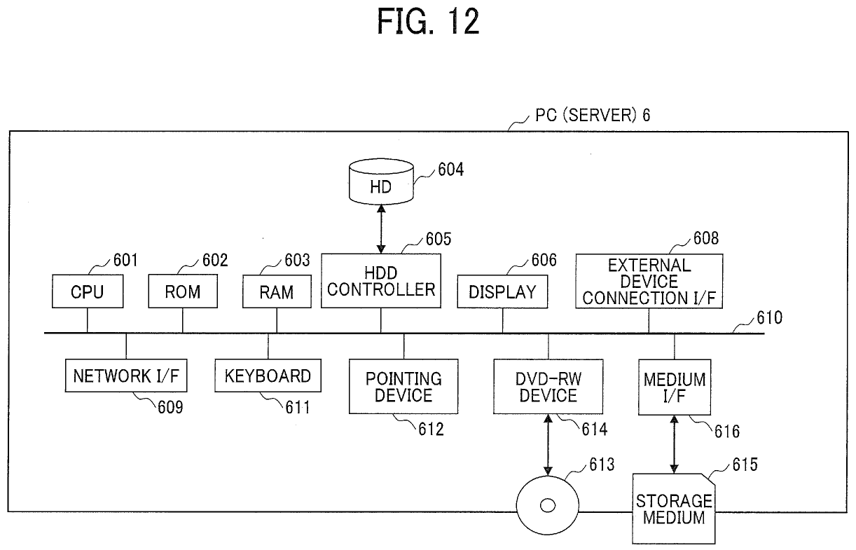

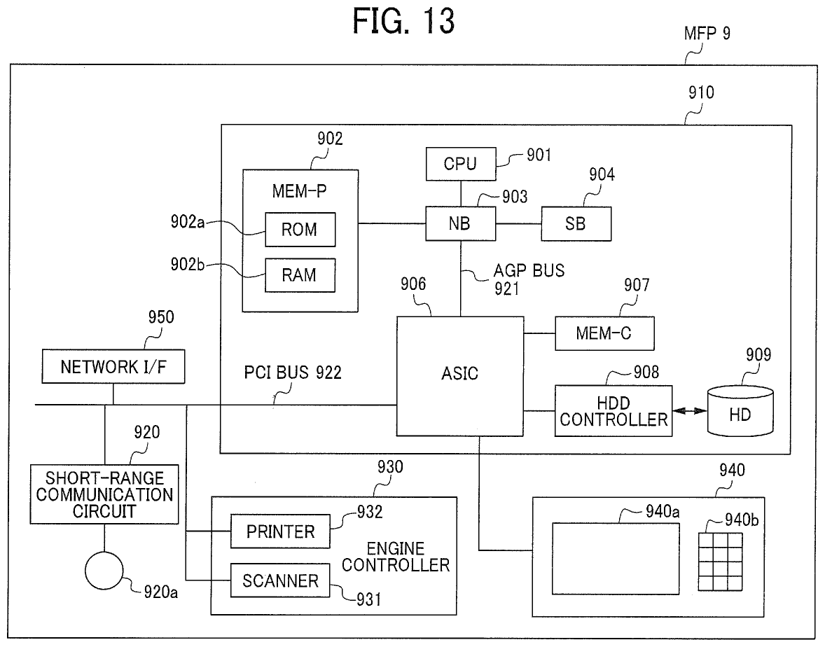

For example, the information processing apparatus 1 according to the present embodiment may be either a PC (server) 6 or an MFP 9 having the hardware configurations illustrated in FIGS. 12 and 13.

FIG. 12 is a hardware configuration diagram of the PC (server). Here, the hardware configuration of the network server 5 is described.

As illustrated in FIG. 12, the server 6 is implemented by a computer, and includes a CPU 601, a ROM 602, a RAM 603, a hard disk (HD) 604, a hard disk drive (HDD) controller 605, a display 606, an external device connection interface (I/F) 608, a network I/F 609, data bus 610, keyboard 611, pointing device 612, a Digital Versatile Disk Rewritable (DVD-RW) drive 614, and medium I/F 616.

The CPU 601 controls entire operation of the server 6. The ROM 602 stores a program such as an initial program loader (IPL) used for driving the CPU 601. The RAM 603 is used as a work area for the CPU 601. The hard disk HD 604 stores various data such as programs. The HDD controller 605 controls reading or writing of various data to the HD 604 according to the control of the CPU 601. The display 606 displays various information such as a cursor, menu, window, character, or image. The external device connection I/F 608 is an interface for connecting various external devices. The external device in this case is, for example, a universal serial bus (USB) memory or a printer. The network I/F 609 is an interface that controls data communication performed with an external device through the communication network. The data bus 610 is an address bus or a data bus, which electrically connects the elements in FIG. 12 such as the CPU 601.

The keyboard 611 is an example of an input device provided with a plurality of keys for allowing a user to input characters, numerals, or various instructions. The pointing device 612 is an example of an input device that allows a user to select or execute a specific instruction, select a target for processing, or move a cursor being displayed. The DVD-RW drive 614 reads and writes various data from and to a DVD-RW 613, which is an example of a removable storage medium. The removable storage medium is not limited to the DVD-RW and may be a digital versatile disc-recordable (DVD-R) or the like. The medium I/F 616 controls reading or writing (storage) of data to a storage medium 615 such as a flash memory.

FIG. 13 is a hardware configuration diagram of the MFP 9. As illustrated in FIG. 13, the MFP 9 includes a controller 910, a short-range communication circuit 920, an engine controller 930, a control panel 940, and a network I/F 950.

The controller 910 includes a CPU 901 as a main processor, a system memory (MEM-P) 902, a north bridge (NB) 903, a south bridge (SB) 904, an Application Specific Integrated Circuit (ASIC) 906, a local memory (MEM-C) 907, an HDD controller 908, and an HD 909 as a storage unit. The NB 903 and the ASIC 906 are connected through an Accelerated Graphics Port (AGP) bus 921.

The CPU 901 is a processor that performs overall control of the MFP 9. The NB 903 connects the CPU 901 with the MEM-P 902, SB 904, and AGP bus 921 and includes a memory controller for controlling reading or writing of various data with respect to the MEM-P 902, a Peripheral Component Interconnect (PCI) master, and an AGP target.

The MEM-P 902 includes a ROM 902a as a memory that stores program and data for implementing various functions of the controller 910 and further includes a RAM 902b as a memory that deploys the program and data, or as a drawing memory that stores drawing data for printing. The program stored in the ROM 902a may be stored in any computer-readable storage medium, such as a compact disc-read only memory (CD-ROM), compact disc-recordable (CD-R), or digital versatile disc (DVD), in a file format installable or executable by the computer for distribution.

The SB 904 connects the NB 903 with a peripheral component interconnect (PCI) device or a peripheral device. The ASIC 906 is an integrated circuit (IC) dedicated to an image processing use, and connects the AGP bus 921, a PCI bus 922, the HDD controller 908, and the MEM-C 907. The ASIC 906 includes a PCI target, an AGP master, an arbiter (ARB) as a central processor of the ASIC 906, a memory controller for controlling the MEM-C 907, a plurality of direct memory access controllers (DMACs) capable of converting coordinates of image data with a hardware logic, and a PCI unit that transfers data between a scanner 931 and a printer 932 through the PCI bus 922. The ASIC 906 may be connected to a USB interface, or the Institute of Electrical and Electronics Engineers 1394 (IEEE1394) interface.

The MEM-C 907 is a local memory used as a buffer for image data to be copied or a code buffer. The HD 909 is a storage for storing image data, font data used during printing, and forms. The HDD controller 908 reads or writes various data from or to the HD 909 under control of the CPU 901. The AGP bus 921 is a bus interface for a graphics accelerator card, which has been proposed to accelerate graphics processing. Through directly accessing the MEM-P 902 by high-throughput, speed of the graphics accelerator card is improved.

Further, the short-range communication circuit 920 includes an antenna for short-range communication circuit 920a. The short-range communication circuit 920 is a communication circuit that communicates in compliance with Near Field Communication (NFC), BLUETOOTH (registered trademark) and the like.

The engine controller 930 includes a scanner 931 and a printer 932. The control panel 940 includes a display panel 940a and an operation panel 940b. The display panel 940a is implemented by, for example, a touch panel that displays current settings or a selection screen and receives a user input. The operation panel 940b includes a numeric keypad that receives set values of various image forming parameters such as image density parameter and a start key that accepts an instruction for starting copying. The controller 910 controls entire operation of the MFP 9. For example, the controller 910 controls rendering, communication, or user inputs to the control panel 940. The scanner 931 or the printer 932 includes an image processing unit such as error diffusion processing and gamma conversion processing.

In response to an instruction to select a specific application through the control panel 940, for example, using a mode switch key, the MFP 9 selectively performs a document box function, a copy function, a print function, and a facsimile function. The document box mode is selected when the document box function is selected, the copy mode is selected when the copy function is selected, the printer mode is selected when the printer function is selected, and the facsimile mode is selected when the facsimile function is selected.

The network I/F 950 controls communication of data with an external device through the communication network. The short-range communication circuit 920 and the network I/F 950 are electrically connected to the ASIC 906 through the PCI bus 922.

The apparatuses described in the examples are merely an illustration of one of several computing environments for implementing the embodiments disclosed herein.

The UUID is an example of identification information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing apparatus comprising:
circuitry configured to:
create in one or more memories, a partition in a verification target area for verifying integrity and authenticity and a partition in a non-verification target area for not verifying the integrity and authenticity;
store a compressed file and authentication data created from the compressed file in the partition in the verification target area of the one or more memories;
verify a signature of the compressed file using the compressed file and the authentication data stored in the partition in the verification target area of the one or more memories; and
based on a successful result of the signature verification, decompress, and expand the compressed file to the partition in the non-verification target area of the one or more memories.

2. The information processing apparatus of claim 1, wherein
when each partition in the verification target area is set according to a type of file system, the circuitry creates the partition in the verification target area according to a type of file system that manages the partition.

3. The information processing apparatus of claim 1, wherein
when each partition in the verification target area is set according to identification information allocated to each partition, the circuitry creates the partition in the verification target area according to the identification information allocated to the partition.

4. The information processing apparatus of claim 1, wherein
the circuitry is further configured to compress all of a plurality of files to generate one compressed file.

5. The information processing apparatus of claim 1, wherein
the circuitry is further configured to verify the signature of the compressed file when the information processing apparatus is started.

6. The information processing apparatus of claim 1, wherein
the circuitry is further configured to cancel decompression and expansion of the compressed file when the signature verification failed.

7. An information processing method comprising:
creating in one or more memories, a partition of a verification target area for verifying integrity and authenticity and a partition of a non-verification target area that does not verify the integrity and authenticity;
storing a compressed file and authentication data created from the compressed file in the partition in the verification target area of the one or more memories;
verifying a signature of the compressed file using the compressed file and the authentication data stored in the partition in the verification target area of the one or more memories; and
based on a successful result of the signature verification, decompressing, and expanding the compressed file to the partition in the non-verification target area of the one or more memories.

8. A non-transitory recording medium which, when executed by one or more processors on an information processing apparatus, cause the processors to perform an information processing method, comprising:
creating in one or more memories, a partition of a verification target area for verifying integrity and authenticity and a partition of a non-verification target area that does not verify the integrity and authenticity;
storing a compressed file and authentication data created from the compressed file in the partition in the verification target area of the one or more memories;
verifying a signature of the compressed file using the compressed file and the authentication data stored in the partition in the verification target area of the one or more memories; and
based on a successful result of the signature verification, decompressing, and expanding the compressed file to the partition in the non-verification target area of the one or more memories.
